(19) United States
(12) Patent Application Publication
(10) Pub. No.: US 2010/0030528 A1
(43) Pub. Date: Feb. 4, 2010

(54) Method, Apparatus, and System for Determining Accurate Location Data Related to Underground Installations

(75) Inventors: Mark A. Smith, Natrona Heights, PA (US); George L. Brandt, Bethel Park, PA (US); Christopher D. Carlin, Sewickley, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Geospatial Mapping Systems, Inc., Sarver, PA (US)

(21) Appl. No.: 12/504,854

(22) Filed: Jul. 17, 2009

Related U.S. Application Data
(60) Provisional application No. 61/081,822, filed on Jul. 18, 2008.

(51) Int. Cl. G06F 17/50; G01S 1/00; G06F 19/00

(52) U.S. Cl. 703/1; 342/357.09; 702/2

(57) ABSTRACT

A system for determining location data related to at least one underground installation includes a non-invasive underground structure detection system, at least one analyzer mechanism, and at least one computer. The non-invasive underground structure detection system is configured to scan a survey area and transmit a first data set at least partially representative of the survey area. The survey area includes at least one underground installation. The at least one analyzer mechanism is configured to measure at least one physical characteristic associated with the at least one underground installation and transmit a second data set at least partially representative of the at least one measured physical characteristic. The at least one computer receives the first transmitted data and the second transmitted data, and determines location data related to the at least one underground installation based at least in part on the first and second transmitted data sets.

### CROSS REFERENCE TO RELATED APPLICATIONS

This application is based on U.S. Provisional Patent Application No. 61/081,822, filed Jul. 18, 2008, on which priority of this patent application is based and which is hereby incorporated by reference in its entirety. This application is also related to co-pending U.S. patent application Ser. No. 12/484,586, filed Jun. 15, 2009, which is also hereby incorporated by reference in its entirety.

### BACKGROUND OF THE INVENTION

1. Field of the Invention

The present invention relates generally to methods, processes, apparatus, and systems for determining location data related to underground installations and objects and, specifically, to a method, apparatus, and system for correcting and/or refining the accuracy of location data produced, for example, by non-invasive systems, and used in the detection of underground installations, structures, and objects.

2. Description of Related Art

Many industries and professions are faced with the challenge of determining the location of underground installations, structures, and various other objects located below ground, and making this determination in a cost-effective manner. More often than not, and due to site conditions and economic feasibility, in some instances, non-invasive methods of detection and location are utilized to obtain this data. While information provided by these methods of detection is useful to the end user, frequently, the accuracy of collected data can be outside of the tolerance required for precise calculations and determinations, based upon the end application and use of this data.

Current non-invasive methods used in the detection and location of underground installations, structures, and objects, such as ground penetrating radar (GPR), radar tomography (RT), electromagnetic induction, and various other geophysical techniques, are affected by variables that can greatly reduce the accuracy of location data produced by such methods. These variables include, but are not limited to: (1) sub-surface soil conditions; (2) composition of the material being located; (3) depth of the material being located; (4) moisture content of the subsurface soil; (5) electromagnetic interference; and (6) human interpretation.

Further, various methods have been developed to help improve the accuracy of data provided by these systems, with most approaches tied to improvements in sensor hardware technology and post-processing software. These approaches have had some success, but the industry is still attempting to find ways to increase the accuracy of the valuable location data provided by these geophysical techniques.

### SUMMARY OF THE INVENTION

Therefore, it is an object of the present invention to provide a method, apparatus, and system for determining accurate location data related to underground installations, structures, and objects that overcome some or all of the drawbacks and deficiencies evident in the prior art and described above.

Preferably, the present invention provides a method, apparatus, and system that is configured to: (1) capture accurate data detailing the physical location and characteristics of an underground pipeline by utilizing an autonomous, inertial based mapping probe, proprietary computer programming logic, proprietary software code, and commercially-available computer aided drafting and design (CADD) software; and (2) utilize this captured data in an automated process to enhance and/or correct the accuracy of data sets produced by non-invasive geophysical techniques used in the detection and location of underground structures and objects.

Accordingly, provided is a system for determining location data related to at least one underground installation. The system includes a non-invasive underground structure detection system, at least one analyzer mechanism, and at least one computer. The non-invasive underground structure detection system is configured to scan a survey area and transmit a first data set at least partially representative of the survey area. The survey area includes at least one underground installation. The at least one analyzer mechanism is configured to measure at least one physical characteristic associated with the at least one underground installation and transmit a second data set at least partially representative of the at least one measured physical characteristic. The at least one computer has a computer readable medium having stored thereon instructions, which, when executed by a processor of the computer, causes the processor to implement the instructions. The at least one computer is in communication with an input mechanism and a display unit. The at least one computer includes programming instructions adapted to operate the processor to receive the first transmitted data and the second transmitted data and programming instructions adapted to operate the processor to determine location data related to the at least one underground installation based at least in part on the first and second transmitted data sets.

The programming instructions adapted to operate the processor to determine location data related to the at least one underground installation may include the generation of a first model based at least in part on the first transmitted data set and the generation of a second model based at least in part on the first model and the second transmitted data set. The at least one computer may further include programming instructions adapted to operate the processor to allow a technician to input an estimated location of the at least one underground installation using the input mechanism based at least in part on the first transmitted data set and produce the first model of the survey area depicting the estimated location of the at least one underground installation. The underground structure detection system may include a communications interface to transmit the first data set to the at least one computer.

The at least one analyzer mechanism may be a probe that includes internal data collection instrumentation configured to measure the at least one physical characteristic and a storage device configured to store collected data. The at least one physical characteristic may include at least one of the following: distance traveled, depth, elevation, angle, change in inclination, change in speed, or any combination thereof. The at least one analyzer mechanism may also include a communications interface to transmit the second data set to the at least one computer.

The at least one computer may further include programming instructions adapted to operate the processor to convert the second data set received from the at least one analyzer mechanism into a readable format. The second data set may include physical characteristic data in three dimensions at at least one specified point along the underground installation.

The at least one computer may further include programming instructions adapted to operate the processor to generate a three-dimensional array of X-Y-Z data representative of physical characteristics of the at least one underground installation. The processor may be further operated to insert the X-Y-Z data into the first model and connect points of the X-Y-Z data to form a complex line representing the at least one underground installation on the first model to produce a second model. Once the second model has been produced, the processor may be further operated to: a) slice the second model into a plurality of vertical layers perpendicular to a length of the second model such that each of the plurality of vertical layers includes first anchor points of the at least one underground installation as determined by the X-Y-Z data from the at least one analyzer mechanism and second anchor points based on an estimated location of the at least one underground installation as determined by the first data set from the non-invasive underground structure detection system; b) examine one of the plurality of vertical layers to identify and calculate a plurality of third anchor points in the vertical layer based on location information of the underground structure detection system transmitted by a location determining system; c) calculate distances from the plurality of third anchor points to the first anchor points and store the calculated distances as first variables; d) calculate distances form the plurality of third anchor points to the second anchor points and store the calculated distances as second variables; e) calculate differences between the first variables and the second variables and store the differences as distance factors; f) calculate vectors of lines created between the first anchor points and the third anchor points and between the second anchor points and the third anchor points and store the vectors as directional factors; g) calculate a new location for the at least one underground installation by applying the distance and directional factors from the third anchor points to the new location; h) repeating steps b) through g) for each of the plurality of vertical layers; and i) reassemble the plurality of vertical layers into a third model having accurately located the at least one underground installation. The location determining system may be a global positioning satellite system.

Further provided is a computer-implemented method on at least one computer having a computer readable medium having stored thereon instructions, which when executed by a processor of the computer, causes the processor to implement the method. The computer implemented method includes the steps of: receiving a first data set transmitted from a non-invasive underground structure detection system configured to scan a survey area that includes at least one underground installation; receiving a second data set transmitted from at least one analyzer mechanism configured to measure at least one physical characteristic associated with the at least one underground installation; and determining location data related to the at least one underground installation based at least in part on the first and second transmitted data sets. The first data set is at least partially representative of the survey area and the second data set is at least partially representative of the at least one physical characteristic.

The step of determining location data related to the at least one underground installation based at least in part on the first and second transmitted data sets may include generating a first model based at least in part on the first transmitted data set and generating a second model based at least in part on the first model and the second transmitted data set. The step of generating the first model may include providing input from a technician to convert the first data set into the first model of the survey area with estimated locations of at least one underground installation. The at least one physical characteristic may include at least one of the following: distance traveled, depth, elevation, angle, change in inclination, change in speed, or any combination thereof.

The computer-implemented method may further include the steps of generating a three-dimensional array of X-Y-Z data representative of physical characteristics of the at least one underground installation; inserting the X-Y-Z data into the first model; and connecting points of the X-Y-Z data to form a complex line representing the at least one underground installation on the first model to produce the second model. Once the second model has been produced, the computer implemented method may further include the steps of: a) slicing the second model into a plurality of vertical layers perpendicular to a length of the second model such that each of the plurality of vertical layers includes first anchor points of the at least one underground installation as determined by the X-Y-Z data from the at least one analyzer mechanism and second anchor points based on an estimated location of the at least one underground installation as determined by the first data set from the underground structure detection system; b) examining one of the plurality of vertical layers to identify and calculate a plurality of third anchor points in the vertical layer based on location information of the underground structure detection system transmitted by a location determining system; c) calculating distances from the plurality of third anchor points to the first anchor points and storing the calculated distances as first variables; d) calculating distances from the plurality of third anchor points to the second anchor points and storing the calculated distances as second variables; e) calculating differences between the first variables and the second variables and storing the differences as distance factors; f) calculating vectors of lines created between the first anchor points and the third anchor points and between the second anchor points and the third anchor points and storing the vectors as directional factors; g) calculating a new location of the at least one underground installation by applying the distance and directional factors from the third anchor points to the new location; h) repeating steps b) through g) for each of the plurality of vertical layers; and i) reassembling the plurality of vertical layers into a third model having accurately located the at least one underground installation.

Still further provided is an article having a machine-readable storage medium containing instructions that, if executed, enable a processor to: receive a first data set transmitted from a non-invasive underground structure detection system configured to scan a survey area that includes at least one underground installation; receive a second data set transmitted from at least one analyzer mechanism configured to measure at least one physical characteristic associated with the at least one underground installation; and determine location data related to the at least one underground installation based at least in part on the first and second transmitted data sets. The first data set is at least partially representative of the survey area, and the second data set is at least partially representative of the at least one physical characteristic.

In addition, provided is an underground installation location determining software stored on a storage medium to analyze a pipeline, the software comprising programming instructions that, if executed, enable a processor to: receive a first data set transmitted from a non-invasive underground structure detection system configured to scan a survey area that includes at least one underground installation; receive a second data set transmitted from at least one analyzer mechanism configured to measure at least one physical characteristic associated with the at least one underground installation; and determine location data related to the at least one underground installation based at least in part on the first and second transmitted data sets. The first data set is at least partially representative of the survey area, and the second data set is at least partially representative of the at least one physical characteristic.

Still further provided is a method for determining location data related to at least one underground installation. The method includes the steps of: scanning a survey area with a non-invasive underground structure detection system, thereby creating a scanned data set at least partially representative of the survey area; transmitting, from the non-invasive underground structure detection system, at least a portion of the scanned data set; measuring, by at least one analyzer mechanism, at least one physical characteristic of at least one underground installation, thereby creating a measurement data set at least partially representative of the at least one physical characteristic; transmitting, from the at least one analyzer mechanism, at least a portion of the measurement data set; receiving the transmitted scanned data set and measurement data set on at least one computer; and determining location data related to the at least one underground installation based at least in part on the scanned data set and the measurement data set. The step of determining location data related to the at least one underground installation based at least in part on the scanned and measurement data sets includes generating a first model based at least in part on the scanned data set and generating a second model based at least in part on the first model and the measurement data set.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a block diagram illustrating an exemplary system for a system for determining location data related to underground installations;

FIG. 2 is a block diagram illustrating an exemplary system for determining location data related to underground installations;

FIG. 3 is a flow chart illustrating a method of determining location data related to an underground installation in accordance with the present invention;

FIGS. 4A and 4B are flow charts illustrating a method of analyzing data from an analyzer mechanism and a non-invasive underground structure detection system to determine location data related to underground installations in accordance with the present invention;

FIG. 5 is a plan view of a survey area produced in accordance with the present invention;

FIG. 6 is a perspective view of a three-dimensional model of the survey area of FIG. 5 produced from data obtained by the non-invasive underground structure detection system;

FIG. 7 is the three-dimensional model of the survey area of FIG. 6 with data regarding underground installations from an analyzer mechanism provided thereon;

FIG. 8 is a plan view of an exemplary vertical layer taken from the three-dimensional model of FIG. 6;

FIG. 9 is a plan view of an exemplary vertical layer taken from the three-dimensional model of FIG. 7 with anchor points provided thereon;

FIG. 10 is a plan view of an exemplary vertical layer taken from the three-dimensional model of FIG. 7 with the position of the underground installations moved to their accurate locations; and

FIG. 11 is a perspective view of a three-dimensional model of the survey area of FIG. 5 with the location of the underground installations accurately located.

### DETAILED DESCRIPTION OF THE PRESENT INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

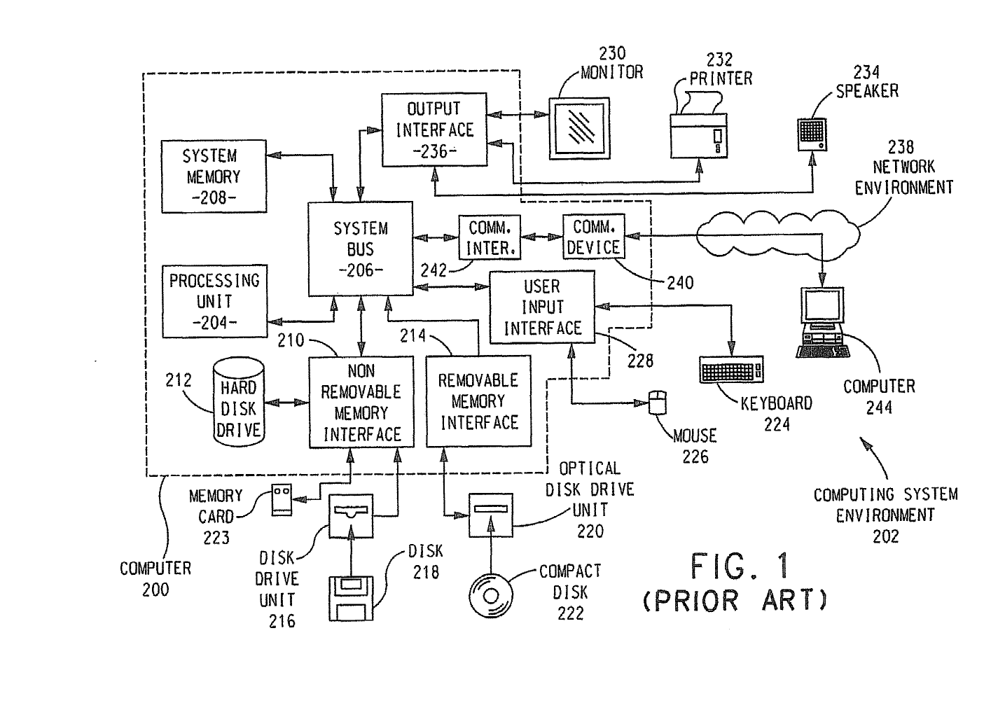

The present invention may be implemented on a variety of computing devices and systems, wherein these computing devices include the appropriate processing mechanisms and computer-readable media for storing and executing computer-readable instructions, such as programming instructions, code, and the like. As illustrated in FIG. 1 and according to the prior art, a schematic and block diagram of exemplary computing devices, in the form of personal computers 200, 244, in a computing system environment 202 are provided. This computing system environment 202 may include, but is not limited to, at least one computer 200 having certain components for appropriate operation, execution of code, and creation and communication of data. For example, the computer 200 includes a processing unit 204 (typically referred to as a central processing unit or CPU) that serves to execute computer-based instructions received in the appropriate data form and format. Further, this processing unit 204 may be in the form of multiple processors executing code in series, in parallel, or in any other manner for appropriate implementation of the computer-based instructions.

In order to facilitate appropriate data communication and processing information between the various components of the computer 200, a system bus 206 is utilized. The system bus 206 may be any of several types of bus structures, including a memory bus or memory controller, a peripheral bus, or a local bus using any of a variety of bus architectures. In particular, the system bus 206 facilitates data and information communication between the various components (whether internal or external to the computer 200) through a variety of interfaces, as discussed hereinafter.

The computer 200 may include a variety of discrete computer-readable media components. For example, this computer-readable media may include any media that can be accessed by the computer 200, such as volatile media, non-volatile media, removable media, non-removable media, etc. As a further example, this computer-readable media may include computer storage media, such as media implemented in any method or technology for storage of information such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 200. Further, this computer-readable media may include communications media, such as computer-readable instructions, data structures, program modules, or other data in a modulated data signal such as a carrier wave or other transport mechanism and include any information delivery media, wired media (such as a wired network and a direct-wired connection), and wireless media (such as acoustic signals, radio frequency signals, optical signals, infrared signals, biometric signals, bar code signals, etc.). Of course, combinations of any of the above should also be included within the scope of computer-readable media.

The computer 200 further includes a system memory 208 with computer storage media in the form of volatile and non-volatile memory, such as ROM and RAM. A basic input/output system (BIOS) with appropriate computer-based routines assists in transferring information between components within the computer 200 and is normally stored in ROM. The RAM portion of the system memory 208 typically contains data and program modules that are immediately accessible to or presently being operated on by processing unit 204, e.g., an operating system, application programming interfaces, application programs, program modules, program data, and other instruction-based computer-readable code.

The computer 200 may also include other removable or non-removable, volatile or non-volatile computer storage media products. For example, the computer 200 may include a non-removable memory interface 210 that communicates with and controls a hard disk drive 212, i.e., a non-removable, non-volatile magnetic medium; and a removable, non-volatile memory interface 214 that communicates with and controls a magnetic disk drive unit 216 (which reads from and writes to a removable, non-volatile magnetic disk 218), an optical disk drive unit 220 (which reads from and writes to a removable, non-volatile optical disk, such as a CD ROM 222), a Universal Serial Bus (USB) port for use in connection with a removable memory card 223, etc. However, it is envisioned that other removable or non-removable, volatile or non-volatile computer storage media can be used in the exemplary computing system environment 202, including, but not limited to, magnetic tape cassettes, DVDs, digital video tape, solid state RAM, solid state ROM, etc. These various removable or non-removable, volatile or non-volatile magnetic media are in communication with the processing unit 204 and other components of the computer 200 via the system bus 206. The drives and their associated computer storage media discussed above and illustrated in FIG. 1 provide storage of operating systems, computer-readable instructions, application programs, data structures, program modules, program data, and other instruction-based computer-readable code for the computer 200 (whether duplicative or not of the information and data in the system memory 208).

A user may enter commands, information, and data into the computer 200 through certain attachable or operable input devices, such as a keyboard 224, a mouse 226, etc., via a user input interface 228. Of course, a variety of such input devices may be utilized, e.g., a microphone, a trackball, a joystick, a touchpad, a touch-screen, a scanner, etc., including any arrangement that facilitates the input of data and information to the computer 200 from an outside source. As discussed, these and other input devices are often connected to the processing unit 204 through the user input interface 228 coupled to the system bus 206, but may be connected by other interface and bus structures, such as a parallel port, game port, or a USB. Still further, data and information can be presented or provided to a user in an intelligible form or format through certain output devices, such as a monitor 230 (to visually display this information and data in electronic form), a printer 232 (to physically display this information and data in print form), a speaker 234 (to audibly present this information and data in audible form), etc. All of these devices are in communication with the computer 200 through an output interface 236 coupled to the system bus 206. It is envisioned that any such peripheral output devices be used to provide information and data to the user.

The computer 200 may operate in a network environment 238 through the use of a communications device 240, which is integral to the computer or remote therefrom. This communications device 240 is operable by and in communication with the other components of the computer 200 through a communications interface 242. Using such an arrangement, the computer 200 may connect with or otherwise communicate with one or more remote computers, such as a remote computer 244, which may be a personal computer, a server, a router, a network personal computer, a peer device, or other common network node, and typically includes many or all of the components described above in connection with the computer 200. Using appropriate communications devices 240, e.g., a modem, a network interface, or adapter, etc., the computer 200 may operate within and communicate through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 200, 244 may be used.

As used herein, the computer 200 includes or is operable to execute appropriate custom-designed or conventional software to perform and implement the processing steps of the method and system of the present invention, thereby forming a specialized and particular computing system. Accordingly, the presently-invented method and system may include one or more computers 200 or similar computing devices having a computer-readable storage medium capable of storing computer-readable program code or instructions that cause the processing unit 204 to execute, configure, or otherwise implement the methods, processes, and transformational data manipulations discussed hereinafter in connection with the present invention. Still further, the computer 200 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

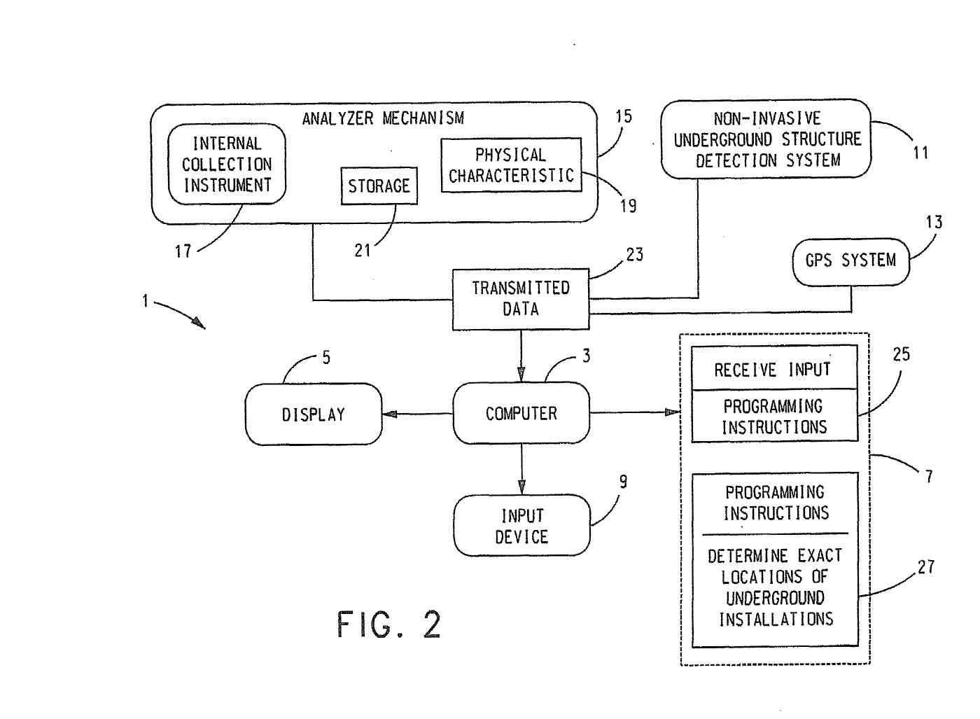

With reference to FIG. 2, one exemplary and non-limiting embodiment of a system, denoted generally as reference numeral 1, for determining location data related to underground installations is provided. System 1 includes at least one computer 3 having some or all of the characteristics of computer 200 discussed hereinabove with reference to FIG. 1 and at least a display 5, a processing unit for reading a computer readable medium 7, and at least one input device 9. System 1 further includes a non-invasive underground structure detection system 11 for scanning a survey area in need of underground structure location. Non-invasive underground structure detection system 11 may be any one of a variety of methods of geophysical investigation such as, but not limited to, ground penetrating radar (GPR), computer assisted radar tomography (CART), ground penetrating imaging radar (GPiR), and electromagnetic locating. A brief description of each of these systems is as follows. GPR is similar to conventional radar. It uses pulses of electromagnetic radiation in the microwave band (i.e., UHF/VHF frequencies) of the radio spectrum and reads the reflected signal to detect subsurface structures and objects without drilling, probing, or otherwise breaking the ground surface. CART is a standard term for GPR systems that combine efficient radar surveying with precise positioning control and advanced signal processing that allows the creation of high-resolution radar images of the subsurface on a large scale. CART may also be referred to as GPiR. Electromagnetic locating is a technology that utilizes a transmitter to apply a signal to an insulated, metallic object. The signal is analyzed using a compatible receiver, thereby allowing the ability to trace the location of the signal and subsequent location of the metallic object. The location of non-invasive underground structure detection system 11 on the surface of the earth, including elevation, is monitored and documented at all times using a global positioning satellite (GPS) system 13 or any other suitable conventional survey equipment.

System 1 also includes an analyzer mechanism 15 that includes internal collection instruments 17 that measure an underground structure and produce physical characteristics 19 of the underground installation based on measurements taken by internal collection instruments 17. A detailed description of analyzer mechanism 15 is provided in related, co-pending U.S. patent application Ser. No. 12/484,586, filed Jun. 15, 2009, which is hereby incorporated by reference in its entirety. Analyzer mechanism 15 may be embodied as an inertial based mapping probe and physical characteristics 19 may be determined based on at least the following measurements taken by the probe: (1) distance traveled; (2) depth; (3) elevation; (4) angle; (5) change in inclination; and (6) speed of the probe. The physical characteristic data can reside on a storage medium 21 of analyzer mechanism 15.

Computer 3 is configured to receive and process transmitted data 23 from non-invasive underground structure detection system 11, GPS system 13, and analyzer mechanism 15. More specifically, computer readable medium 7 of system 1 includes programming instructions 25 to control the processor of computer 3 to receive the transmitted data 23 from non-invasive underground structure detection system 11, GPS system 13, and analyzer mechanism 15. Computer readable medium 7 also includes programming instructions determining location data related to underground installations 27 based on the information received from non-invasive underground structure detection system 11, GPS system 13, and analyzer mechanism 15. The programming instructions 27 include instructions for performing the functions described hereinafter.

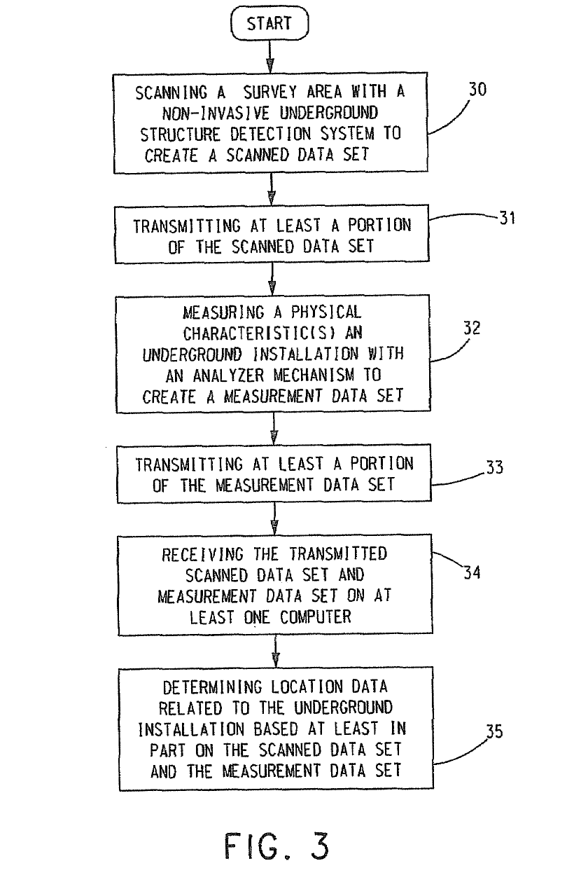

With reference to FIG. 3, a high level overview of the method performed by system 1 to determine location data related to underground installations is provided. The process begins at step 30 where a survey area is scanned with non-invasive underground structure detection system 11 to create a scanned data set. Thereafter, at step 31, at least a portion of the scanned data set is transmitted to computer 3. In step 32, at least one physical characteristic of an underground installation is measured with analyzer mechanism 15 to create a measurement data set. Then, at step 33, at least a portion of the measurement data set is transmitted to computer 3. The transmitted scanned data set and measurement data set are then received by computer 3 at step 34. Finally, at step 35, location data related to the underground installation is determined based at least in part on the scanned data set and the measurement data set. The above described process will be described in greater detail hereinafter.

### Non-Invasive Detection of Underground Structures

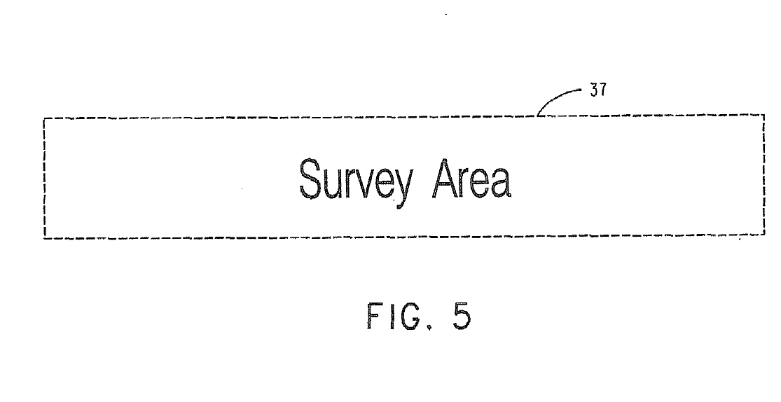

The step of scanning the survey area in step 30 is performed as follows. First, a place or location in need of underground structure location is identified and designated as the survey area 37 as shown in FIG. 5. Thereafter, one or more qualified field technicians scan survey area 37 using non-invasive underground structure detection system 11. The location of the scanning equipment on the surface of the earth, including elevation, is monitored and documented at all times using GPS system 13. The location information is determined to be as exact as possible.

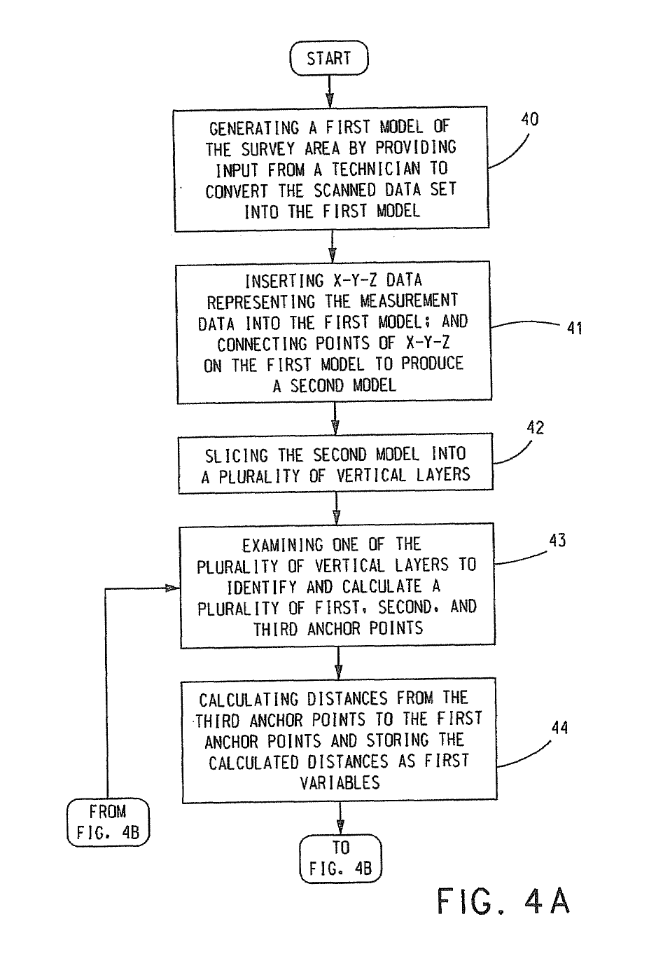

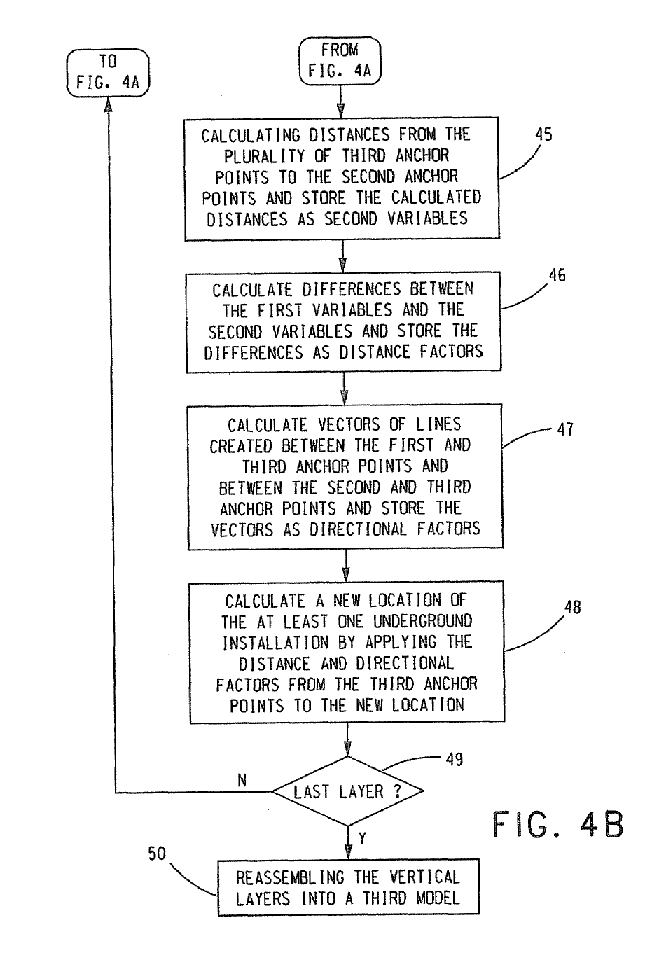

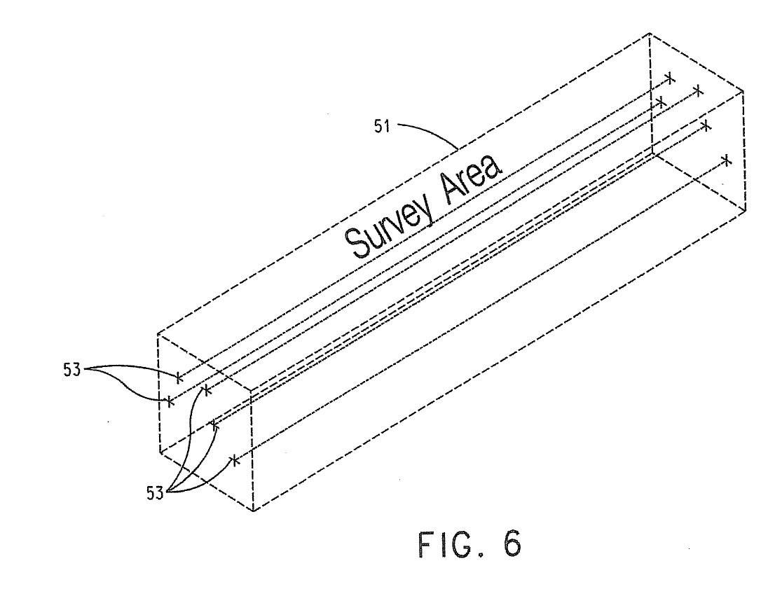

With reference to FIGS. 4A and 4B, and with continuing reference to FIGS. 2 and 3, raw output (i.e., scanned data) from the scan by non-invasive underground structure detection system 11 is collected and delivered to computer 3, and processed into a usable format. At step 40, a qualified office technician examines the processed data and estimates the location of all underground installations using accepted industry practices and procedures. Alternatively, programming instructions may be provided to control the processor of computer 3 to estimate the location of all underground installations in survey area 37. A three-dimensional first model 51, as shown in FIG. 6, depicting the location of all the underground installations 53 is then produced by system 1. The location of the underground installations is determined on first model 51 within the tolerance of the scanning equipment. This tolerance varies depending on subsurface conditions, soil composition, and geographical location of survey area 37. System 1 can display first model 51 on the screen of display 5. A CADD or GIS package can be used to implement such a display.

### Measuring a Physical Characteristic of the Underground Installations

The step of measuring at least one physical characteristic of an underground installation with analyzer mechanism 15 to create a measurement data set at step 32 is performed as follows. First, one or more underground installations 53 from first model 51 are accurately located using analyzer mechanism 15. As described hereinabove, analyzer mechanism 15 may be embodied as an inertial based mapping probe. However, this is not to be construed as limiting the present invention as any suitable analyzer mechanism capable of measuring a physical characteristic of an underground installation may be utilized.

In one preferred and non-limiting embodiment, underground installations 53 chosen for location with analyzer mechanism 15 embodied as an inertial based mapping probe are as follows: (1) located as far away from ground surface as possible, while still remaining in survey area 37; and (2) run as close as possible to the entire length of survey area 37. Analyzer mechanism 15 is configured to be inserted into one end of an open underground installation, such as a pipe, and travel to the other open end, and it may be manually or mechanically pulled via a rope, cable, or line through underground installation 53. It can also be pushed through the underground installation 53 via air, fluid, or robotic propulsion.

Analyzer mechanism 15 includes internal data collection instruments 17 and components that measure at least the following: (1) distance traveled; (2) depth; (3) elevation; (4) angle; (5) change in inclination; and (6) speed of the probe. In addition, it further includes an internal storage medium 21 that stores the information collected, allowing the analyzer mechanism to travel autonomously and un-tethered through the underground installation.

Analyzer mechanism 15 may also include communication devices to transfer, wirelessly, data it receives either immediately, at a programmed time, or at a set interval while traveling through underground installation 53. Analyzer mechanism 15 includes an array of data collection instruments which include accelerometers, gyroscopes, and odometers located within each of the probe bodies thereof. As analyzer mechanism 15 moves through the underground installation it can record all changes in inclination, heading, and velocity at a rate of 800 times per second. This information is stored on storage medium 21 within analyzer mechanism 15.

Analyzer mechanism 15 is not restricted by the depth of ground cover over the underground installation 53 nor is it subject to possible interference derived from other underground installations or metals located within the soil. There is no requirement to “trace” the movement of analyzer mechanism 15 from above ground. Analyzer mechanism 15 is provided with its starting coordinates and its ending coordinates, and internal data collection instruments 17 along with the software record everywhere that analyzer mechanism 15 travels between those known coordinates.

Depending on the underground installation interior surface and condition, various wheel-sets with protruding carrier legs are used to assure the positioning of the probe body of analyzer mechanism 15 within the underground installation. The ability to economically design and develop multiple specifications for the probe bodies or carriers of analyzer mechanism 15 and utilize the same instrumentation modules is a key element to the analyzer mechanism technology. Modifying the probe bodies of analyzer mechanism 15 allows operations in high pressure, high temperature, and many caustic environments. The basic analyzer mechanism 15 is designed for use within a non-pressurized pipeline environment. However, analyzer mechanisms 15 have been designed and are in use in pressurized environments up to 6.55 bar (95 psi). Analyzer mechanisms 15 can be capable of operating in environments up to 241 bar (3500 psi) with battery and memory capacities allowing for very long distance runs.

Analyzer mechanism 15 can have over thirty instruments to collect approximately 800 accurate readings per second as the probe moves within the underground installation. This physical characteristic data is saved on storage device 21 within analyzer mechanism 15 and then transmitted at the end of the run to computer 3. The physical characteristic data collection method type is not meant to be a limiting feature of the invention as one skilled in the art may envision other known techniques to measure the physical characteristics of the pipeline.

After surveying the underground installation, analyzer mechanism 15 is removed from the end of the underground installation. Analyzer mechanism 15 communicates with a physical characteristics analyzer, a computer, or other data holding device having programming instructions to perform calculations. An example of such a computer 3 is described hereinabove with reference to FIG. 2. The physical characteristic data is then transmitted by analyzer mechanism 15 to computer 3 where it can be processed or stored in memory on computer 3. The transmission can occur via USB or other wired communication techniques or also using wireless or memory storage cards and disks. Programming instructions 25 on computer 3 operate a processor to process the transmitted data 23 from all the instruments in analyzer mechanism 15 and process and convert the data into a readable format describing the analyzer mechanism's exact location in three dimensions, i.e., X-Y-Z data, at any given point along the underground installation as follows:
763594.870000, 2877717.700000, 210.470000
763594.413419, 2877719.926949, 210.463260
763594.413419, 2877719.926949, 210.463260
763594.265899, 2877720.646380, 210.460034
763594.064304, 2877721.629357, 210.455267
763593.863577, 2877722.606496, 210.451348
763593.660874, 2877723.592634, 210.448455

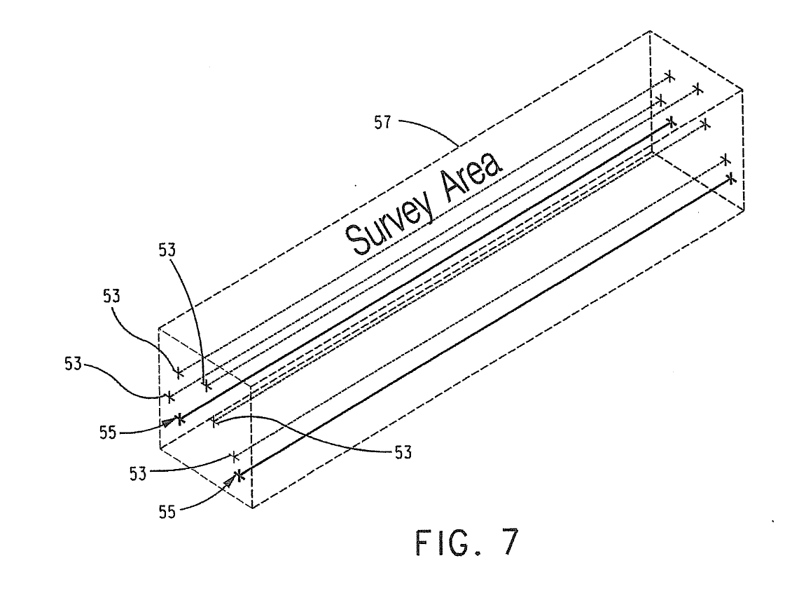

With continued reference to FIGS. 4A and 4B, the readable X-Y-Z data is then inserted into first model 51, and this X-Y-Z data or points will be connected via a line segment in the order of collection at step 41. All the points collected from one underground installation are connected to form a complex line representing the probed underground installation 55, or an attribute of the underground installation, such as centerline of the underground installation. The result of this process is the formation of a second three-dimensional model 57 as shown in FIG. 7 having the probed underground installations 55 and the scanned underground installations 53 shown thereon.

### Spatially Adjusting the Second Three-Dimensional Model

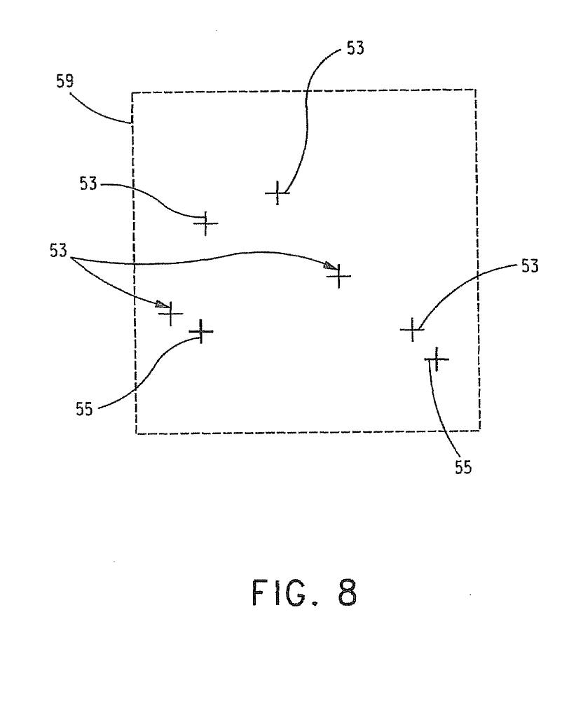

As discussed hereinabove, system 1 of the present invention, which may or may not operate in conjunction with a commercially available CADD package or other GIS/sketching/drawing software package, may be executed on a computer 3 having first and second models 51, 57 stored thereon. With continued reference to FIGS. 4A and 4B, computer 3 of system 1 includes programming instructions 27 to “slice” second model 57 into thin vertical layers or slices 59 that are perpendicular to a length of second model 57 at step 42. The thickness of slices 59 will vary depending on the complexity of the model and available computer processing resources. The slices can range in thickness from sub-centimeter (for very complex models) to greater than one foot (for less complex models). An example of such a slice is shown in FIG. 8.

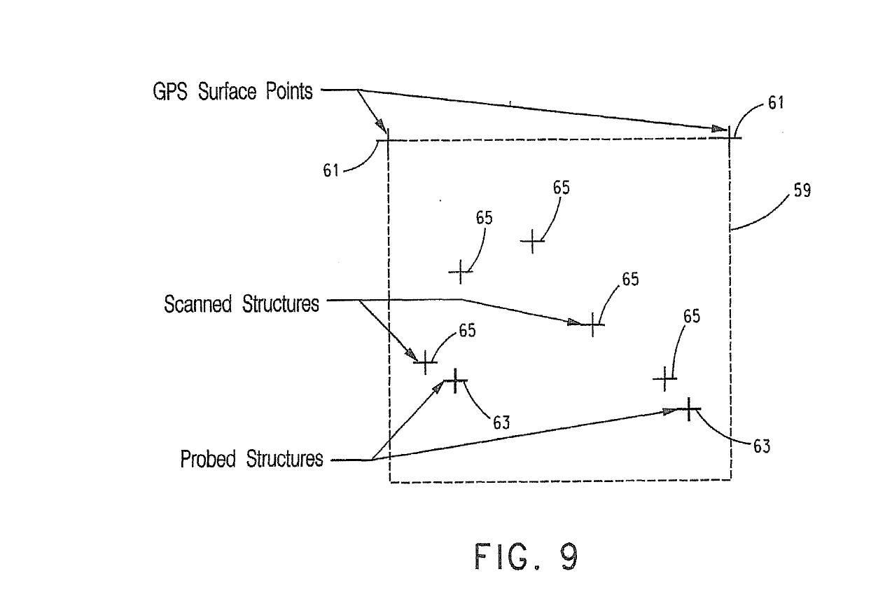

Next, at step 43, programming instructions 27 instruct the processor of computer 3 to examine a first slice 59 and identify and calculate exact anchor points 61 in the slice 59. These anchor points 61 are accurately located points from second model 57 at the exact place that slice 59 exists in survey area 37. Anchor points 61 include the GPS points or conventional survey points collected from the location of non-invasive underground structure detection system 11 by GPS system 13 on the surface of the earth. These are the third anchor points described in the flow chart of FIGS. 4A and 4B. If no exact point exists, an exact point will be calculated by computing the intersection of the slice with a plane created by the surface points and the intersection of the slice 59 with the complex line representing the probed underground installations 55. Anchor points 61 are used as anchors in the spatial adjustment process and will not be altered. Programming instructions 27 then instruct the processor of computer 3 to examine a first slice 59 and calculate the locations of the remaining structures using the intersecting process as described above. These points are then placed on slice 59 as well. First anchor points 63 represent the probed underground installation 55 and second anchor points 65 represent the scanned underground installation 53. An example of slice 59 with first anchor points 63, second anchor points 65, and third anchor points 61 provided thereon is show in FIG. 9.

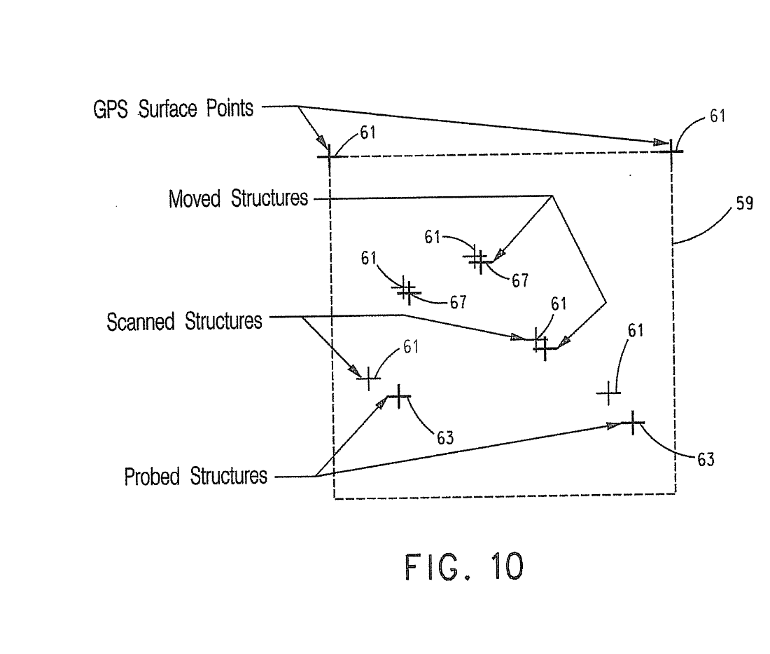

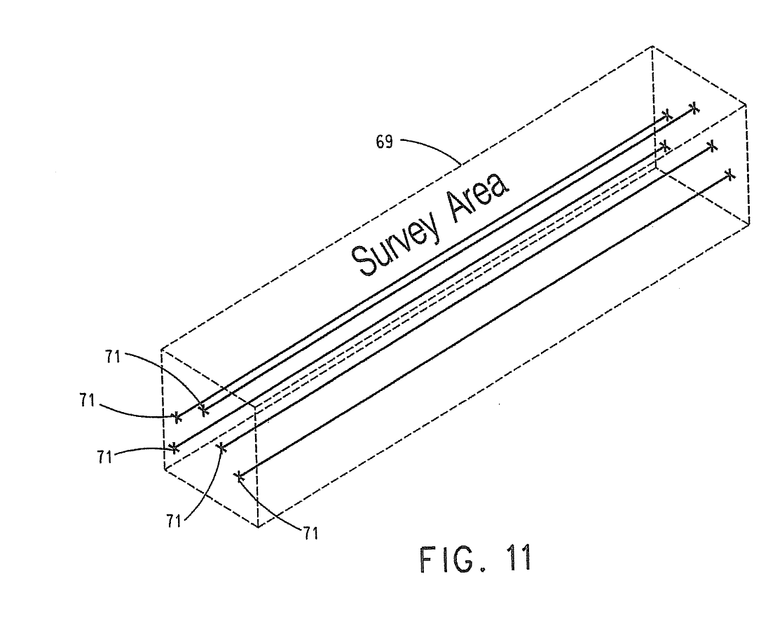

Next, at step 44, programming instructions 27 instruct the processor of computer 3 to calculate distances from third anchor points 61 in slice 59 to first anchor points 63 of the probed underground installations 55 and store these distances as first variables. At step 45, programming instructions 27 also instruct the processor of computer 3 to calculate the distance between the same third anchor points 61 in slice 59 to second anchor points 65 of the scanned underground installations 53 and store these distances as second variables. Thereafter, at step 46, programming instructions 27 instruct the processor of computer 3 to calculate the difference between the first variables representing the first set of distances between third anchor points 61 and first anchor points 63 and the second variables representing the second set of distances between third anchor points 61 and second anchor points 65. These differences are then stored as distance factors. At step 47, programming instructions 27 further instruct the processor of computer 3 to calculate the vectors of the lines created between the anchor points described above and store these values as directional factors. Next, at step 48, programming instructions 27 also instruct the processor of computer 3 to calculate new location points 67 for all the underground installations in slice 59 by applying the distance and directional factors, or some percentage thereof, from the known, third anchor points 61 to the current locations of the underground installations. An example of a slice 59 with the structures moved to their more accurate new location points is shown in FIG. 10.

At decision block 49, it is determined if the last slice 59 has been processed as described above. If the last slice 59 has not been processed, programming instructions 27 instruct the processor of computer 3 to return to step 43 and repeat the above-described method and process for each slice 59 from second model 57.

If the last slice 59 has been processed, programming instructions 27 instruct the processor of computer 3 to reassemble the slices 59 into a new third three-dimensional model 69 at step 50. Programming instructions 27 instruct the processor of computer 3 to connect the more accurate points for each underground installation creating third three-dimensional model 69 with accurately located underground installations 71. An example of this revised three dimensional model is provided in FIG. 8.

Accordingly, the system and method of the present invention is configured to capture accurate data detailing the physical location and characteristics of an underground by utilizing an analyzer mechanism 15 and utilize this captured data in an automated process to enhance and/or correct the accuracy of data sets produced by non-invasive underground structure detection system 11. More specifically, the system and method of the present invention perform the following steps: scanning the survey area 37 with non-invasive underground structure detection system 11, thereby creating a scanned data set at least partially representative of the survey area 37; measuring, by at least one analyzer mechanism 15, at least one physical characteristic of at least one underground installation, thereby creating a measurement data set at least partially representative of the at least one physical characteristic; and determining location data related to the at least one underground installation based at least in part on the scanned data set and the measurement data set. In this manner, underground installations in survey area 37 can be accurately located.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements. For example, it is to be understood that the present invention contemplates that, to the extent possible, one or more features of any embodiment can be combined with one or more features of any other embodiment.

The invention claimed is:

1. A system for determining location data related to at least one underground installation, comprising:
a non-invasive underground structure detection system configured to scan a survey area and transmit a first data set at least partially representative of the survey area, wherein the survey area includes at least one underground installation;
at least one analyzer mechanism configured to measure at least one physical characteristic associated with the at least one underground installation and transmit a second data set at least partially representative of the at least one measured physical characteristic; and
at least one computer having a computer readable medium having stored thereon instructions, which, when executed by a processor of the computer, causes the processor to implement the instructions, wherein the at least one computer is in communication with an input mechanism and a display unit, the at least one computer comprising programming instructions adapted to operate the processor to receive the first transmitted data and the second transmitted data and adapted to operate the processor to determine location data related to the at least one underground installation based at least in part on the first and second transmitted data sets.

2. The system as defined in claim 1, wherein the programming instructions adapted to operate the processor to determine location data related to the at least one underground installation includes generation of a first model based at least in part on the first transmitted data set and generation of a second model based at least in part on the first model and the second transmitted data set.

3. The system as defined in claim 2, wherein the at least one computer further comprises programming instructions adapted to operate the processor to allow a technician to input an estimated location of the at least one underground installation using the input mechanism based at least in part on the first transmitted data set and produce the first model of the survey area depicting an estimated location of the at least one underground installation.

4. The system as defined in claim 1, wherein the underground structure detection system further comprises a communications interface to transmit the first data set to the at least one computer.

5. The system as defined in claim 1, wherein the at least one analyzer mechanism is a probe including:
internal data collection instrumentation configured to measure the at least one physical characteristic; and
a storage device configured to store collected data.

6. The system as defined in claim 1, wherein the at least one physical characteristic includes at least one of the following: distance traveled, depth, elevation, angle, change in inclination, change in speed, or any combination thereof.

7. The system as defined in claim 1, wherein the at least one analyzer mechanism further comprises a communications interface to transmit the second data set to the at least one computer.

8. The system as defined in claim 1, wherein the at least one computer further comprises programming instructions adapted to operate the processor to convert the second data set received from the at least one analyzer mechanism into a readable format.

9. The system as defined in claim 1, wherein the second data set comprises physical characteristic data in three dimensions at at least one specified point along the at least one underground installation.

10. The system as defined in claim 2, wherein the at least one computer further comprises programming instructions adapted to operate the processor to generate a three-dimensional array of X-Y-Z data representative of physical characteristics of the at least one underground installation.

11. The system as defined in claim 10, wherein the at least one computer further comprises programming instructions adapted to operate the processor to insert the X-Y-Z data into the first model and connect points of the X-Y-Z data to form a complex line representing the at least one underground installation on the first model to produce a second model.

12. The system as defined in claim 11, wherein the at least one computer further comprises programming instructions adapted to operate the processor to:
a) slice the second model into a plurality of vertical layers perpendicular to a length of the second model such that each of the plurality of vertical layers includes first anchor points of the at least one underground installation as determined by the X-Y-Z data from the at least one analyzer mechanism and second anchor points based on an estimated location of the at least one underground installation as determined by the first data set from the non-invasive underground structure detection system;
b) examine one of the plurality of vertical layers to identify and calculate a plurality of third anchor points in the vertical layer based on location information of the underground structure detection system transmitted by a location determining system;
c) calculate distances from the plurality of third anchor points to the first anchor points and store the calculated distances as first variables;
d) calculate distances from the plurality of third anchor points to the second anchor points and store the calculated distances as second variables;
e) calculate differences between the first variables and the second variables and store the differences as distance factors;
f) calculate vectors of lines created between the first anchor points and the third anchor points and between the second anchor points and the third anchor points and store the vectors as directional factors;
g) calculate a new location for the at least one underground installation by applying the distance and directional factors from the third anchor points to the new location;
h) repeating steps b) through g) for each of the plurality of vertical layers; and
i) reassemble the plurality of vertical layers into a third model having accurately located the at least one underground installation.

13. The system as defined in claim 12, wherein the location determining system is a global positioning satellite system.

14. A computer-implemented method on at least one computer having a computer readable medium having stored thereon instructions, which when executed by a processor of the computer, causes the processor to implement the method, comprising:
receiving a first data set transmitted from a non-invasive underground structure detection system configured to scan a survey area that includes at least one underground installation, wherein the first data set is at least partially representative of the survey area;
receiving a second data set transmitted from at least one analyzer mechanism configured to measure at least one physical characteristic associated with the at least one underground installation, wherein the second data set is at least partially representative of the at least one physical characteristic; and
determining location data related to the at least one underground installation based at least in part on the first and second transmitted data sets.

15. The computer-implemented method defined in claim 14, wherein the step of determining location data related to the at least one underground installation based at least in part on the first and second transmitted data sets includes generating a first model based at least in part on the first transmitted data set and generating a second model based at least in part on the first model and the second transmitted data set.

16. The computer-implemented method defined in claim 15, wherein the step of generating the first model comprises providing input from a technician to convert the first data set into the first model of the survey area with estimated locations of at least one underground installation.

17. The computer-implemented method defined in claim 14, wherein the at least one physical characteristic includes at least one of the following: distance traveled, depth, elevation, angle, change in inclination, change in speed, or any combination thereof.

18. The computer-implemented method defined in claim 15, further comprising the step of generating a three-dimensional array of X-Y-Z data representative of physical characteristics of the at least one underground installation.

19. The computer-implemented method defined in claim 18, further comprising the step of inserting the X-Y-Z data into the first model and connecting points of the X-Y-Z data to form a complex line representing the at least one underground installation on the first model to produce the second model.

20. The computer-implemented method defined in claim 19, further comprising the steps of:
a) slicing the second model into a plurality of vertical layers perpendicular to a length of the second model such that each of the plurality of vertical layers includes first anchor points of the at least one underground installation as determined by the X-Y-Z data from the at least one analyzer mechanism and second anchor points based on an estimated location of the at least one underground installation as determined by the first data set from the underground structure detection system;
b) examining one of the plurality of vertical layers to identify and calculate a plurality of third anchor points in the vertical layer based on location information of the underground structure detection system transmitted by a location determining system;
c) calculating distances from the plurality of third anchor points to the first anchor points and storing the calculated distances as first variables;
d) calculating distances from the plurality of third anchor points to the second anchor points and storing the calculated distances as second variables;
e) calculating differences between the first variables and the second variables and storing the differences as distance factors;
f) calculating vectors of lines created between the first anchor points and the third anchor points and between the second anchor points and the third anchor points and storing the vectors as directional factors;
g) calculating a new location of the at least one underground installation by applying the distance and directional factors from the third anchor points to the new location;
h) repeating steps b) through g) for each of the plurality of vertical layers; and
i) reassembling the plurality of vertical layers into a third model having accurately located the at least one underground installation.

21. An article comprising a machine-readable storage medium containing instructions that, if executed, enable a processor to:
receive a first data set transmitted from a non-invasive underground structure detection system configured to scan a survey area that includes at least one underground installation, wherein the first data set is at least partially representative of the survey area;
receive a second data set transmitted from at least one analyzer mechanism configured to measure at least one physical characteristic associated with the at least one underground installation, wherein the second data set is at least partially representative of the at least one physical characteristic; and
determine location data related to the at least one underground installation based at least in part on the first and second transmitted data sets.

22. An underground installation location determining software stored on a storage medium to analyze a pipeline, the software comprising programming instructions that, if executed, enable a processor to:
receive a first data set transmitted from a non-invasive underground structure detection system configured to scan a survey area that includes at least one underground installation, wherein the first data set is at least partially representative of the survey area;
receive a second data set transmitted from at least one analyzer mechanism configured to measure at least one physical characteristic associated with the at least one underground installation, wherein the second data set is at least partially representative of the at least one physical characteristic; and
determine location data related to the at least one underground installation based at least in part on the first and second transmitted data sets.

23. A method for determining location data related to at least one underground installation, comprising:
scanning a survey area with a non-invasive underground structure detection system, thereby creating a scanned data set at least partially representative of the survey area;
transmitting, from the non-invasive underground structure detection system, at least a portion of the scanned data set;
measuring, by at least one analyzer mechanism, at least one physical characteristic of at least one underground installation, thereby creating a measurement data set at least partially representative of the at least one physical characteristic;
transmitting, from the at least one analyzer mechanism, at least a portion of the measurement data set;
receiving the transmitted scanned data set and measurement data set on at least one computer; and
determining location data related to the at least one underground installation based at least in part on the scanned data set and the measurement data set.

24. The method defined in claim 23, wherein the step of determining location data related to the at least one underground installation based at least in part on the scanned and measurement data sets includes generating a first model based at least in part on the scanned data set and generating a second model based at least in part on the first model and the measurement data set.
